(19) United States
(12) Patent Application Publication
(10) Pub. No.: US 2015/0280217 A1
(43) Pub. Date: Oct. 1, 2015

(54) THREE-DIMENSIONAL GRAPHENE-BACKBONED ARCHITECTURES AND METHODS OF MAKING THE SAME

(71) Applicants: Yongji Gong, Houston, TX (US); Shubin Yang, Houston, TX (US); Pulickel M. Ajayan, Houston, TX (US)

(72) Inventors: Yongji Gong, Houston, TX (US); Shubin Yang, Houston, TX (US); Pulickel M. Ajayan, Houston, TX (US)

(73) Assignee: William Marsh Rice University, Houston, TX (US)

(21) Appl. No.: 14/204,680

(22) Filed: Mar. 11, 2014

Related U.S. Application Data
(60) Provisional application No. 61/776,171, filed on Mar. 11, 2013.

(51) Int. Cl. H01M 4/36; H01M 10/0525; H01M 4/525; H01M 4/583; H01M 4/58; H01M 4/485

(52) U.S. Cl. CPC H01M 4/364; H01M 4/5815; H01M 4/485; H01M 4/525; H01M 4/583; H01M 10/0525

(57) ABSTRACT

In some embodiments, the present disclosure pertains to methods of making three-dimensional graphene compositions. In some embodiments, the methods comprise: (1) associating a graphene oxide with a metal source to form a mixture; and (2) reducing the mixture. In some embodiments, the method results in formation of a three-dimensional graphene composition that includes: (a) a reduced metal derived from the metal source; and (b) a graphene derived from the graphene oxide, where the graphene is associated with the reduced metal. In some embodiments, the metal source is (NH₄)₂MoS₄, and the reduced metal is MoS₂. In some embodiments, the metal source is V₂O₅, and the reduced metal is VO₂. Further embodiments of the present disclosure pertain to the formed three-dimensional graphene compositions and their use as electrode materials in energy storage devices.

### CROSS-REFERENCE TO RELATED APPLICATIONS

This application claims priority to U.S. Provisional Patent Application No. 61/776,171, filed on Mar. 11, 2013. The entirety of the aforementioned application is incorporated herein by reference.

### STATEMENT REGARDING FEDERALLY SPONSORED RESEARCH

This invention was made with government support under Grant No. W911NF-11-1-0362, awarded by the U.S. Department of Defense. The government has certain rights in the invention.

### BACKGROUND

Many energy storage devices have high energy densities. However, many energy storage devices suffer from a lack of suitable electrode materials that enable rapid charge-discharge capability and high power density. Various embodiments of present disclosure address these limitations.

### SUMMARY

In some embodiments, the present disclosure pertains to methods of making three-dimensional graphene compositions. In some embodiments, the methods of the present disclosure comprise: (1) associating a graphene oxide with a metal source to form a mixture; and (2) reducing the mixture. In some embodiments, the method results in formation of a three-dimensional graphene composition that includes: (a) a reduced metal derived from the metal source; and (b) a graphene derived from the graphene oxide, where the graphene is associated with the reduced metal.

In some embodiments, the associating step occurs by a method selected from the group consisting of mixing, sonication, dispersion, heating, hydrothermal treatment, and combinations thereof. In some embodiments, the reducing step comprises heating the mixture. In some embodiments, the reducing step comprises exposure of the mixture to a reducing agent, such as hydrazine, sodium borohydride, diamine, and combinations thereof. In some embodiments, the associating step and the reducing step occur simultaneously.

In some embodiments, the reducing step results in the reduction of the metal source to the reduced metal. In some embodiments, the metal source is (NH₄)₂MoS₄, and the reduced metal is MoS₂. In some embodiments, the metal source is FeCl₃.6H₂O, and the reduced metal is FeO. In some embodiments, the metal source is V₂O₅, and the reduced metal is VO₂.

In some embodiments, the reduced metal forms a crystalline lattice on the graphene. In some embodiments, the reduced metal forms a uniform layer on the graphene.

In some embodiments, the reducing step results in the reduction of the graphene oxide to the graphene. In some embodiments, the graphene is derived by unzipping of the graphene oxide. In some embodiments, the graphene is selected from the group consisting of graphene nanoribbons, graphene nanosheets, single-crystalline graphene, graphene monolayers, graphene multilayers, and combinations thereof. In some embodiments, the graphene forms a continuous network of interconnected monolayers in the three-dimensional graphene composition. In some embodiments, the graphene forms discontinuous monolayers in the three-dimensional graphene composition.

Further embodiments of the present disclosure pertain to the formed three-dimensional graphene compositions. Additional embodiments of the present disclosure pertain to the use of the formed three-dimensional graphene composition as electrode materials in energy storage devices, such as lithium ion batteries.

### DESCRIPTION OF THE FIGURES

FIG. 1 provides a scheme for the fabrication of three-dimensional graphene compositions.

FIG. 2 provides images and illustrations of various three-dimensional graphene architectures. FIG. 2A illustrates the fabrication of various three-dimensional graphene architectures constructed by numerous metal oxide (VO₂)-graphene nanoribbons or other metal oxides/sulfides (MoS₂)-graphene hybrid nanosheets via a simultaneous hydrothermal synthesis and reduction procedure at 180° C. Structural model of layered, orthorhombic V₂O₅ phase projected along facet is shown on the top left of FIG. 2A. Illustrations of graphene oxide sheets and (NH₄)₂MoS₄ dispersions in water are shown in the middle and left down of FIG. 2A, respectively. FIG. 2B shows a field emission scanning electron microscope (FE-SEM) image of a VO₂-graphene sample hydrothermally treated for 12 h to form a three-dimensional architecture constructed by numerous graphene nanoribbons with the width of 200-600 nm and lengths of several tens of micrometers. FIG. 2C shows an FE-SEM image of a MoS₂-graphene sample hydrothermally treated for 12 h to form a three-dimensional architecture constructed by numerous nanosheets with the size of several micrometers.

FIG. 3 shows various images of VO₂ ribbons, the building blocks of various three-dimensional VO₂-graphene architectures. FIG. 3A shows a transmission electron microscopy (TEM) image of individual ribbons with rectangular ends and flexible graphene sheets. FIGS. 3B-C show high resolution TEM (HRTEM) images of discontinuous graphene layers on the surface of well-crystalline ribbons. The exposed lattice fringes shown in FIG. 3C has a spacing of 0.21 nm, corresponding to the (003) plane of VO₂. FIG. 3D shows representative diffraction patterns that illustrate well-defined arrays of dots, demonstrating the single crystalline feature of VO₂(B) ribbons. FIGS. 3E-H show scanning transmission electron microscopy (STEM) images and corresponding elemental mapping of vanadium (FIG. 3F), oxygen (FIG. 3G), and carbon (FIG. 3H), indicating the homogeneous dispersion of V, O and C in all the ribbons.

FIG. 4 shows various images of MoS₂-graphene hybrid sheets, the building blocks of various three-dimensional MoS₂-graphene architectures. FIG. 4A shows typical TEM image of MoS₂-graphene architectures, showing the thin and continuous walls. FIG. 4B shows an HRTEM image of a typical sheet, revealing the hexagonal crystal structure of MoS₂ on the surface of graphene sheets. FIGS. 4C-D show STEM images of MoS₂-graphene sheets (FIG. 4C) and its corresponding S and C element mapping (FIG. 4D), revealing the homogeneous dispersion of S and C in the building nanosheets. The green and blue colors in FIG. 4D stand for sulfur and carbon atoms, respectively.

FIG. 5 shows data relating to the electrochemical performance of VO₂-graphene architectures under room temperature. FIG. 5A shows representative discharge-charge curves of VO₂-graphene (78%) architecture at various C-rates (1C, 5C, 12C and 28C) over the potential range of 1.5-3.5 V vs. Li⁺/Li. FIG. 5B shows rate capacities of VO₂-graphene architectures with different VO₂ contents, measured for 30 cycles at each selected rate from 1C to 190C. After the rate capacity test at 190 C, the current rate is regained to 1C for another 30 cycles. FIG. 5C shows capacity retentions of VO₂-graphene architectures when performing full discharge-charge at the highest rate of 190C (37.2 A g⁻¹) for 1000 cycles. 1′ and 2′ are denoted as VO₂-graphene architectures with the VO₂ contents of 78% and 68%, respectively. All the electrochemical measurements (a-c) were carried out at room temperature in two-electrode 2032 coin-type half cells using Li metal as the anode.

FIG. 6 shows data relating to the electrochemical performances of three-dimensional MoS₂-graphene architectures as anode materials for lithium storage. FIG. 6A shows representative discharge-charge curves of MoS₂-graphene architecture (85%) at various C-rates (0.5C, 2C 5C, 12C and 43C) over the potential range of 0.0-3.0 V vs. Li⁺/Li. FIG. 6B shows cycle performance of MoS₂/graphene architectures with different MoS₂ contents (85% and 65%) at a current rate of 0.5C (600 mA/g). FIG. 6C shows capacity retentions of MoS₂-graphene (85%) architecture when performing full discharge-charge for 3000 cycles at the charge-discharge rate of 12C, 43C and 140C, respectively.

FIG. 7 provides data relating to the formation process of VO₂-graphene architectures and their application for lithium storage. At the initial stage (FIG. 7A, <1.5 h), V₂O₅ was dissolved into water and covered onto the surface of graphene oxide (GO) sheets. With the increase of reaction time from 1.5 to 4 h (FIG. 7B), V₂O₅ was partially reduced to irregular ribbons by the functional groups such as phenol and hydroxyl on GO. Meanwhile, the resulting ribbons became building blocks to construct 3D architectures during the hydrothermal process. Most of GO sheets became invisible at this stage, indicating that GO sheets were unzipped to graphene nanoribbons along with the formation and crystallization of VO₂ ribbons, which can be demonstrated by the HRTEM images of VO₂ ribbons (incontinuous graphene are coated onto the surface of VO₂ ribbons). With the further increase of reaction time to 12 h (FIG. 7C), three-dimensional architectures constructed by numerous VO₂ ribbons with thin, flexible and single-crystalline features and incontinuous graphene layers were generated. FIG. 7D depicts lithium storage in three-dimensional VO₂-graphene architectures (12 h), where the electrolyte (light red) fills the pores, facilitating the fast diffusion of lithium ions from electrolyte to the surface of VO₂ ribbons, and where the three-dimensional interpenetrating network is favorable for the rapid diffusion of electrons.

FIG. 8 shows the thermogravimetric analysis (TGA) of VO₂-graphene architectures with different VO₂ contents. The TGA were carried out from 30° C. to 800° C. with the heating rate of 10° C. min⁻¹ in air. It is indicated that the V₂O₅ residues after TGA tests are 92.4%, 85.6% and 74.9% for the VO₂-graphene architectures synthesized with the different ratio of 9:1, 4:1 and 1.5:1 between V₂O₅ and GO, respectively. Correspondingly, the contents of VO₂ in the three VO₂-graphene architectures are 84%, 78%, and 68%, respectively.

FIG. 9 provides data relating to the thickness analysis of VO₂-graphene nanoribbons. FIG. 9A shows a representative AFM image of a VO₂-graphene nanoribbon. FIG. 9B shows a corresponding thickness analysis taken around the green line in FIG. 9A, revealing a uniform thickness of about 10 nm for the ribbons.

FIG. 10 shows typical TEM image, EDX and EELS of VO₂ graphene nanoribbons. FIG. 10A is a TEM image showing several ribbons with the widths of 200-600 nm. FIGS. 10B-C are EDS and EELS analyses revealing the co-existence of vanadium, oxygen and carbon in the VO₂ ribbons. The atomic ratio between vanadium and oxygen is about 2:1.

FIG. 11 shows HRTEM images of VO₂ graphene nanoribbons with different magnifications, including 10 nm (FIG. 11A) and 5 nm (FIG. 11B). The HRTEM images show the incontinuous structure of graphene on the surface of VO₂ well-crystalline ribbons. The red line frameworks show the exposed single-crystalline VO₂ area.

FIG. 12 provides a crystal structure of VO₂-graphene architectures. FIG. 12A shows XRD patterns that are entirely indexed in the space group C2/m with standard lattice constants (a=12.03 Å, b=3.693 Å, c=6.42 Å (β=106.6o)) for VO₂(B) with a monoclinic structure. FIG. 12B shows a structural model of monoclinic VO₂(B) phase projected along [010] facet on the basis of the XRD analysis of FIG. 12A.

FIG. 13 shows XPS and Raman spectra of VO₂-graphene architectures with different VO₂ contents. FIG. 13A shows an XPS survey that reveals the co-existence of vanadium, oxygen and carbon in all the VO₂-graphene architectures. FIG. 13B shows the Raman spectra of VO₂-graphene architectures with three different VO₂ contents of 84%, 78% and 68%, indicating the monoclinic VO₂(B) phase. Raman spectra at 195, 224, 340, 390, 480 and 618 cm⁻¹ correspond to Ag symmetry, and that at 312 cm⁻¹ is of Bg symmetry. FIGS. 13C-D show high resolution (e) V2p3/2 and (f) O1s XPS spectra of 3D architectures. The spectra reveal that the ratios between V and O are about 1:2.

FIG. 14 shows the structural characteristics of VO₂-graphene architectures with different VO₂ contents. FIG. 14A shows nitrogen adsorption/desorption isotherms that demonstrate the porous structure with BET surface areas of 405, 156 and 66 m² g⁻¹ for the VO₂-graphene architectures with the different VO₂ contents of 68.3%, 78.1% and 84.3%, respectively. FIG. 14B show pore size distributions that reveal that the pore sizes in VO₂-graphene architectures are in the range of 3-30 nm.

FIG. 15 shows rate capacities of VO₂-graphene architectures with the VO₂ content of 84% under room temperature. The rate capacities were measured for 30 cycles at each selected rate from 1C to 84C.

FIG. 16 shows capacity retention of VO₂-graphene architectures with the VO₂ content of 68% when performing full discharge-charge at the highest rate of 190 C for 3000 cycles under room temperature.

FIG. 17 shows the electrochemical performance of VO₂-graphene architectures with the VO₂ content of 84% under various temperatures. FIG. 17A shows the cycle performance under various temperatures at a current rate of 5° C. FIG. 17B shows capacity retentions under the highest temperature of 75° C. at a current rate of 28° C.

FIG. 18 shows the capacity retention of VO₂-graphene architectures with the VO₂ content of 68% when performing full discharge-charge at a current rate of 28° C. under the highest temperature of 75° C.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Energy storage devices (e.g., lithium ion batteries) are integral power sources in several of today's technologies. However, the achievement of high-rate capability in energy storage devices is known to be hindered by kinetic problems involving slow ion and electron diffusions in the electrode materials. Thus, reducing the characteristic dimensions of electrochemically active materials can become an effective strategy to enhance the cycling rates of various energy storage devices. For instance, in lithium ion batteries, the diffusion time t of lithium ions is proportional to the square of the diffusion length L (t=L²/D).

Accordingly, numerous nanoscale materials (including nanowires, nanotubes, nanoparticles, nanosheets and nanoribbons) have been recently synthesized and demonstrated for improved electrochemical performances for ion (e.g., lithium) storage. However, only modest improvements in rate performances have been observed due to difficulties in simultaneously possessing efficient ion and electron pathways in simple nanomaterials.

To further circumvent this problem, various three-dimensional architectures with high electrical conductivity have been employed to serve as current collectors for nanomaterials. Although some improvements in charging and discharging rates with minimal capacity loss have been achieved, these architectures commonly lead to the high-weight fraction of current collectors in electrodes, thereby decreasing the overall energy density of energy storage devices (e.g., batteries). Moreover, the complicated and limited fabrication approaches to three-dimensional architectures largely hamper their practical applications in many energy storage devices (e.g., lithium ion batteries).

Accordingly, a need exists for improved methods of making three-dimensional energy storage materials. A need also exists for three-dimensional energy storage materials with enhanced charge-discharge capabilities and high power densities. The present disclosure addresses these needs.

In some embodiments, the present disclosure pertains to methods of making three-dimensional graphene compositions that can be used as electrode materials in energy storage devices. In some embodiments, the present disclosure pertains to the formed three-dimensional graphene compositions.

Methods of Making Three-Dimensional Graphene Compositions

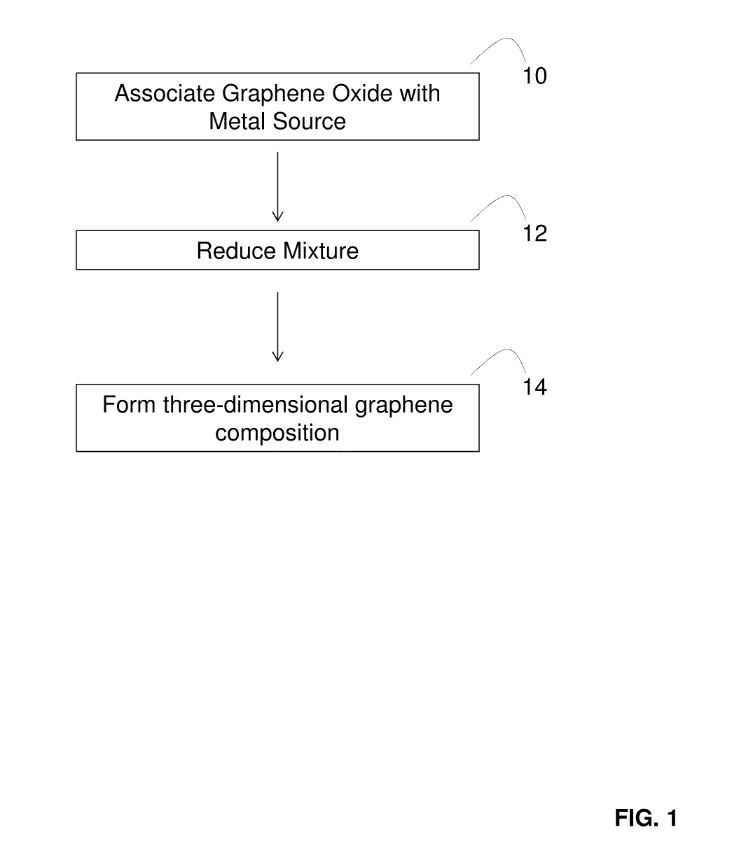

In some embodiments, the present disclosure pertains to methods of making three-dimensional graphene compositions by the following steps illustrated in FIG. 1: (1) associating a graphene oxide with a metal source to form a mixture (step 10); and (2) reducing the mixture (step 12) to result in the formation of three-dimensional graphene compositions (step 14). In some embodiments, the formed three-dimensional graphene compositions include a reduced metal derived from the metal source and a graphene derived from the graphene oxide, where the graphene is associated with the reduced metal.

As set forth in more detail herein, the methods of the present disclosure have numerous embodiments. In particular, various methods may be utilized to associate graphene oxides with various types of metal sources to form various types of mixtures. Likewise, various methods may be utilized to reduce the mixtures to form various types of three-dimensional graphene compositions.

Association of Graphene Oxides with Metal Sources

Various methods may be utilized to associate graphene oxides with metal sources. In some embodiments, the associating occurs by a method that includes, without limitation, mixing, sonication, dispersion, heating, hydrothermal treatment, and combinations thereof. In some embodiments, the associating step occurs by sonication.

In some embodiments, the associating step occurs by hydrothermal treatment. In some embodiments, the hydrothermal treatment occurs by dispersing graphene oxides and metal sources in an aqueous solution and heating the solution at high temperatures for several hours. In more specific embodiments, hydrothermal treatment occurs by dispersing graphene oxides and metal sources in an aqueous solution and heating the solution at temperatures between about 100° C. and 200° C. for 6-20 hours. In some embodiments, hydrothermal treatment occurs by dispersing graphene oxides and metal sources in water and heating the solution at about 180° C. for 12 hours. Additional methods by which to associate graphene oxides with metal sources can also be envisioned.

Metal Sources

Graphene oxides may become associated with various metal sources. In some embodiments, the metal sources include, without limitation, metals, metal oxides, metal sulfides, transition metals, transition metal oxides, transition metal sulfides, salts thereof, and combinations thereof. In more specific embodiments, the metal sources may include a molybdenum (Mo) source, such as (NH₄)₂MoS₄. In some embodiments, the metal sources may include an iron (Fe) source, such as FeCl₃.6H₂O. In some embodiments, the metal sources may include a vanadium (V) source, such as V₂O₅. The use of additional metal sources can also be envisioned.

Reduction of Formed Mixtures

Various methods may also be utilized to reduce mixtures that include graphene oxides and metal sources. For instance, in some embodiments, the reducing step includes heating the mixture. In some embodiments, the reducing step includes exposure of the mixture to a reducing agent. In some embodiments, the reducing agent includes, without limitation, hydrazine, sodium borohydride, diamine, and combinations thereof.

In some embodiments, the reducing step may occur independently from the step of associating graphene oxides with metal sources. In some embodiments, the reducing step and the associating step occur simultaneously. In some embodiments, the reducing step occurs after the associating step. In some embodiments, the reducing step occurs before the associating step.

In some embodiments the reducing step results in the reduction of the metal source to a reduced metal. In some embodiments, the reducing step results in the reduction of graphene oxide to graphene. In some embodiments, the reducing step results in the formation of three-dimensional graphene compositions.

Reduced Metals

In some embodiments, reduced metals are derived from the reduction of a metal source. In some embodiments, the reduced metals may include, without limitation, metals, metal oxides, metal sulfides, transition metals, transition metal oxides, transition metal sulfides, and combinations thereof.

In some embodiments, the reduced metal is derived from a molybdenum (Mo) source. In some embodiments, the reduced metal is MoS₂, such as MoS₂ derived from the reduction of (NH₄)₂MoS₄.

In some embodiments, the reduced metal is derived from an iron (Fe) source. In some embodiments, the reduced metal is FeO, such as FeO derived from the reduction of FeCl₃.6H₂O.

In some embodiments, the reduced metal is derived from a vanadium (V) source. In some embodiments, the reduced metal is VO₂, such as VO₂ derived from V₂O₅.

Association of Reduced Metals with Graphene

The reduced metals may become associated with graphenes in various manners. For instance, in some embodiments, the reduced metals may form a crystalline lattice on a graphene surface. In more specific embodiments, the reduced metals may form a hexagonal crystalline lattice on a graphene surface. In further embodiments, the reduced metals may form a hexagonal crystalline lattice of MoS₂ on a surface of graphene sheets.

In some embodiments, the reduced metal forms a uniform layer on a graphene surface. In some embodiments, the uniform layer has a thickness ranging from about 5 nm to about 100 nm on the graphene surface. In some embodiments, the uniform layer has a thickness of about 10 nm on the graphene surface.

In some embodiments, the reduced metal constitutes from about 50% to about 90% by weight of the three-dimensional graphene composition. In more specific embodiments, the reduced metal constitutes from about 60% to about 85% by weight of the three-dimensional graphene composition. In some embodiments, the reduced metal constitutes about 68%, about 78%, or about 84% by weight of the three-dimensional graphene composition.

Graphenes

Various types of graphenes may be incorporated into the three-dimensional graphene compositions of the present disclosure. In some embodiments, the graphenes may be derived from the reduction of graphene oxide during a reducing step. In some embodiments, the graphene may be derived by unzipping the graphene oxide.

In some embodiments, the graphene may include, without limitation, graphene nanoribbons, graphene nanosheets, single-crystalline graphene, graphene monolayers, graphene multilayers, and combinations thereof. In some embodiments, the graphene includes graphene nanosheets. In some embodiments, the graphene includes graphene nanoribbons.

The graphenes in the three-dimensional graphene compositions of the present disclosure may also have various widths. For instance, in some embodiments, the graphene includes widths ranging from about 200 nm to about 600 nm. In some embodiments, the graphene includes widths ranging from about 10 μm to about 100 μm.

The graphenes in the three-dimensional graphene compositions of the present disclosure may also have various thicknesses. For instance, in some embodiments, the graphenes may have thicknesses ranging from about 1 nm to about 1 μm. In some embodiments, the graphenes may have thicknesses ranging from about 1 nm to about 50 nm. In some embodiments, the graphenes may have thicknesses ranging from about 1 nm to about 20 nm.

The graphenes may also have various arrangements in the three-dimensional graphene compositions of the present disclosure. For instance, in some embodiments, the graphenes may form a continuous network of interconnected monolayers in the three-dimensional graphene composition. In some embodiments, the graphenes may form a discontinuous monolayer in the three-dimensional graphene composition.

Formed Three-Dimensional Graphene Compositions

The methods of the present disclosure may result in the formation of various three-dimensional graphene compositions with various properties. For instance, in some embodiments, the formed three-dimensional graphene compositions have a porous structure with a plurality of pores. In some embodiments, the plurality of pores have diameters that range from about 3 nm to about 30 nm.

In some embodiments, the formed three-dimensional graphene compositions have various surface areas. For instance, in some embodiments, the formed three-dimensional graphene compositions have surface areas of about 100 m²/g to about 500 m²/g. In some embodiments, the formed three-dimensional graphene compositions have surface areas of about 250 m²/g.

In some embodiments, the formed three-dimensional graphene compositions may include graphene nanosheets that are associated with MoS₂. In some embodiments, the MoS₂ is derived from the reduction of (NH₄)₂MoS₄.

In some embodiments, the formed three-dimensional graphene compositions may include graphene nanoribbons that are associated with VO₂. In some embodiments, the VO₂ is derived from the reduction of V₂O₅.

Three-Dimensional Graphene Compositions

In further embodiments, the present disclosure pertains to three-dimensional graphene compositions that include a graphene and a metal associated with the graphene, where the three-dimensional graphene composition has a three-dimensional architecture. In some embodiments, the metal in the three-dimensional graphene composition includes, without limitation, metals, metal oxides, metal sulfides, transition metals, transition metal oxides, transition metal sulfides, and combinations thereof. In some embodiments, the metal is MoS₂. In some embodiments, the metal is FeO. In some embodiments, the metal is VO₂.

In some embodiments, the metal constitutes from about 50% to about 90% by weight of the three-dimensional graphene composition. In more specific embodiments, the metal constitutes from about 60% to about 85% by weight of the three-dimensional graphene composition. In some embodiments, the metal constitutes about 68%, about 78%, or about 84% by weight of the three-dimensional graphene composition.

In some embodiments, the graphene in the three-dimensional graphene composition includes, without limitation, graphene nanoribbons, graphene nanosheets, single-crystalline graphene, graphene monolayers, graphene multilayers, and combinations thereof. In some embodiments, the graphene includes graphene nanosheets. In more specific embodiments, the graphene includes graphene nanoribbons. In some embodiments, the graphene includes single-crystalline graphene. In some embodiments, the graphene includes monolayers. In some embodiments, the graphene forms a continuous network of interconnected monolayers in the three-dimensional graphene composition. In some embodiments, the graphene forms a discontinuous monolayer in the three-dimensional graphene composition.

In more specific embodiments, the metal in the three-dimensional graphene composition includes MoS₂, and the graphene includes graphene nanosheets. In some embodiments, the metal in the three-dimensional graphene composition includes VO₂, and the graphene includes graphene nanoribbons.

In some embodiments, the metal in the three-dimensional graphene composition forms a crystalline lattice on the graphene. In some embodiments, the metal in the three-dimensional graphene composition forms a uniform layer on the graphene. In some embodiments, the three-dimensional graphene composition has a porous structure with a plurality of pores. In some embodiments, the pores include diameters that range from about 3 nm to about 30 nm.

In some embodiments, the three-dimensional graphene composition has a surface area of about 250 m²/g. In some embodiments, the three-dimensional graphene composition is utilized as an electrode material in an energy storage device. In some embodiments, the energy storage device is a battery, such as a lithium ion battery.

Applications and Advantages

As set forth in more detail in the Examples herein, the three-dimensional graphene compositions of the present disclosure possess favorable kinetics for both lithium and electron diffusions. For instance, ultrafast-rate capabilities of full charge to discharge in 20-30 seconds are achieved. More remarkably, the three-dimensional graphene compositions of the present disclosure can cycle over 1000 times, retaining more than 90% of the initial capacities at ultrahigh rates (190C).

Accordingly, Applicants expect numerous applications for the three-dimensional graphene compositions of the present disclosure. For instance, in some embodiments, the three-dimensional graphene compositions of the present disclosure may be utilized as electrode materials (e.g., cathode or anode materials) in various energy storage devices. In some embodiments, the energy storage devices that utilize the three-dimensional graphene compositions may include batteries, such as lithium ion batteries.

### ADDITIONAL EMBODIMENTS

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1

### Ultrafast-Rate Battery Materials from Graphene-Containing Three-Dimensional Architectures

In this Example, Applicants demonstrate an efficient bottom-up approach to construct various graphene-containing three-dimensional architectures from numerous two-dimensional ribbons or sheets. Two VO₂-graphene nanoribbons and MoS₂-graphene naosheets constructed architectures are chosen as typical examples. These graphene-containing architectures possess favorable kinetics for both lithium and electron diffusions. Ultrafast-rate capabilities of full charge to discharge in 20-30 seconds are achieved. More remarkably, these materials cycle over 1000 times, retaining more than 90% of the initial capacities at ultrahigh rates (190C), providing the best rate performances for lithium ion batteries reported yet.

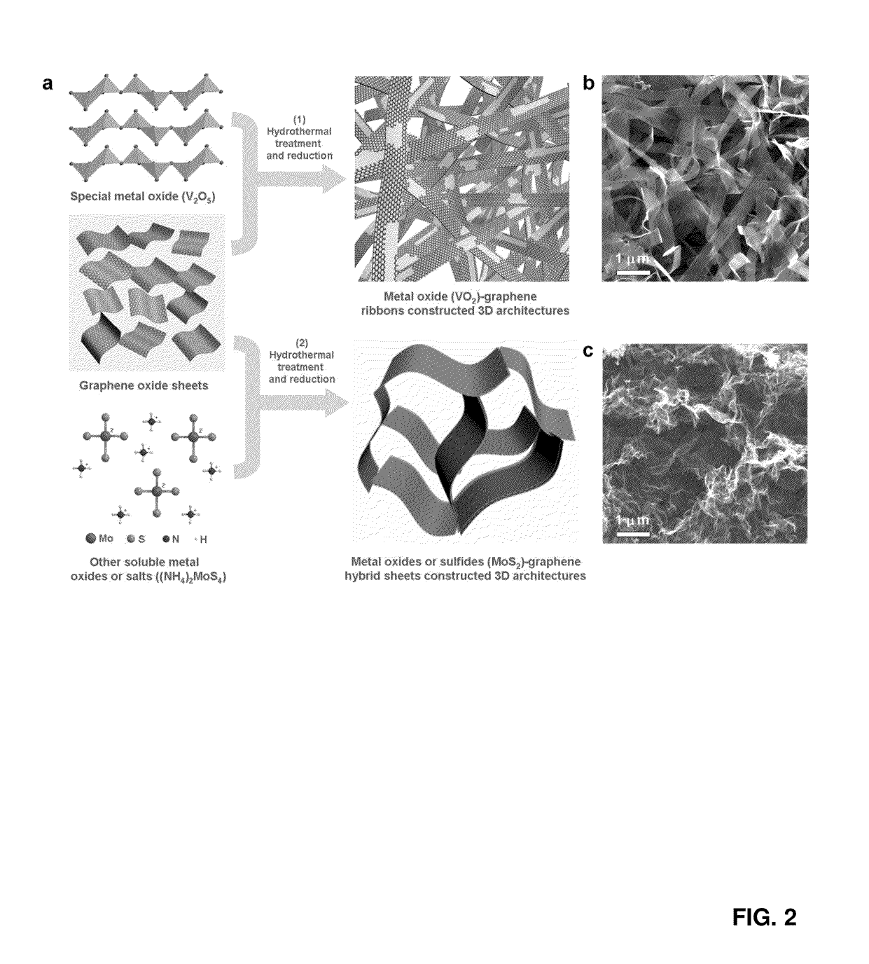

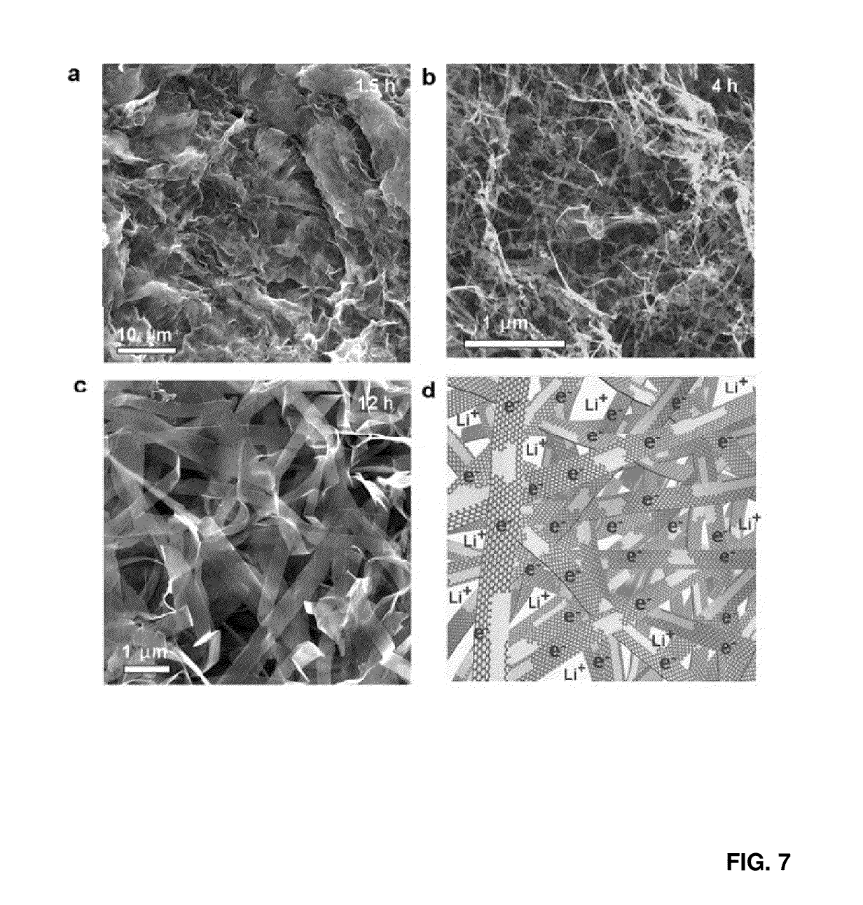

In particular, Applicants demonstrate in this Example a simple synthesis approach for various three-dimensional architectures constructed from two-dimensional (2D) ribbons or sheets, where VO₂-graphene nanoribbons or MoS₂-graphene nanosheets are chosen as two typical examples (FIG. 2). Due to the thinness of the building blocks (ribbons or nanosheets), the hybrid conducting nature due to the presence of graphene layers, and the three dimensional architecture from the interpenetrating ribbons or nanosheets, the materials satisfy the kinetics requirements for ultrafast charging and discharging of an ideal electrode material (i.e., rapid ion and electron diffusions) (FIG. 7D). As a consequence, it is demonstrated that these architectures enable the ultrafast charging and discharging rates with optimal cycle performances while maintaining high reversible capacities.

Applicants fabricated the three-dimensional graphene-containing architectures by a simultaneous hydrothermal synthesis and chemical reduction procedure (See Example 1.1). VO₂ and MoS₂ were chosen as two examples owing to their high theoretical capacities as cathode and anode materials for lithium storage, respectively. To controllably fabricate the three-dimensional graphene-containing architectures, graphene oxide (GO) was used as the substrates for the in-situ growth of VO₂ ribbons and MoS₂ nanosheets via the reductions of V₂O₅ with GO and (NH₄)₂MoS₄ with NH₂NH₂, respectively. These reactions were carried out at a constant temperate of 180° C. in Teflon-lined autoclaves, where V₂O₅ and (NH₄)₂MoS₄ were initially dissolved in water and dispersed onto the surface of GO sheets, and then gradually reduced to VO₂-graphene nanoribbons and MoS₂-graphene nanosheets (FIG. 7).

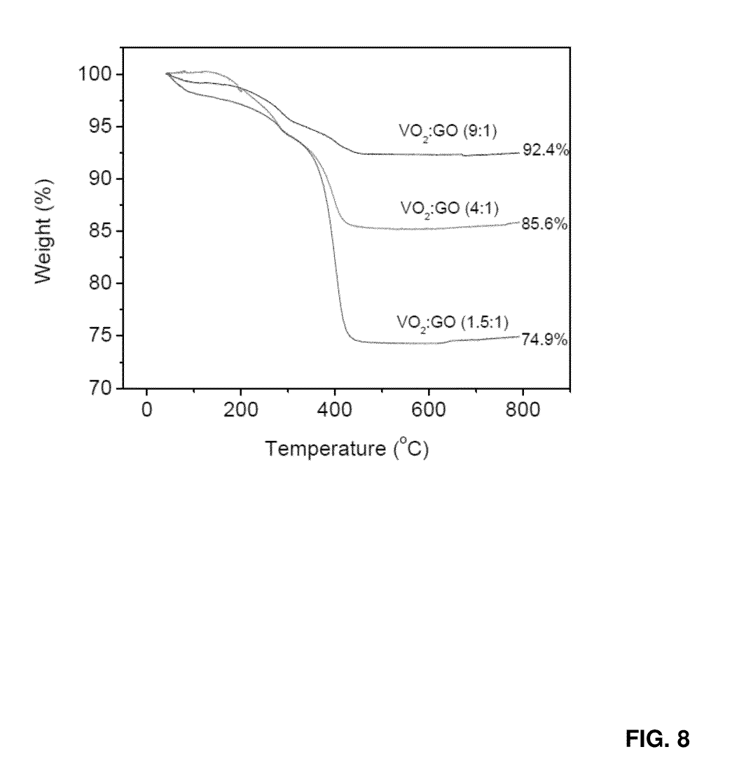

The resulting ribbons or nanosheets simultaneously became building blocks for the construction of three-dimensional interpenetrating architectures. Notably, the contents of VO₂ and MoS₂ in the as-prepared architectures were readily tunable by simply adjusting the ratio of metal precursors to GO during the synthesis process. Thus, VO₂-graphene and MoS₂-graphene architectures with various VO₂ (84%, 78% and 68%) and MoS₂ (85% and 65%) contents were generated as estimated by thermogravimetric analysis (TGA) (FIG. 8).

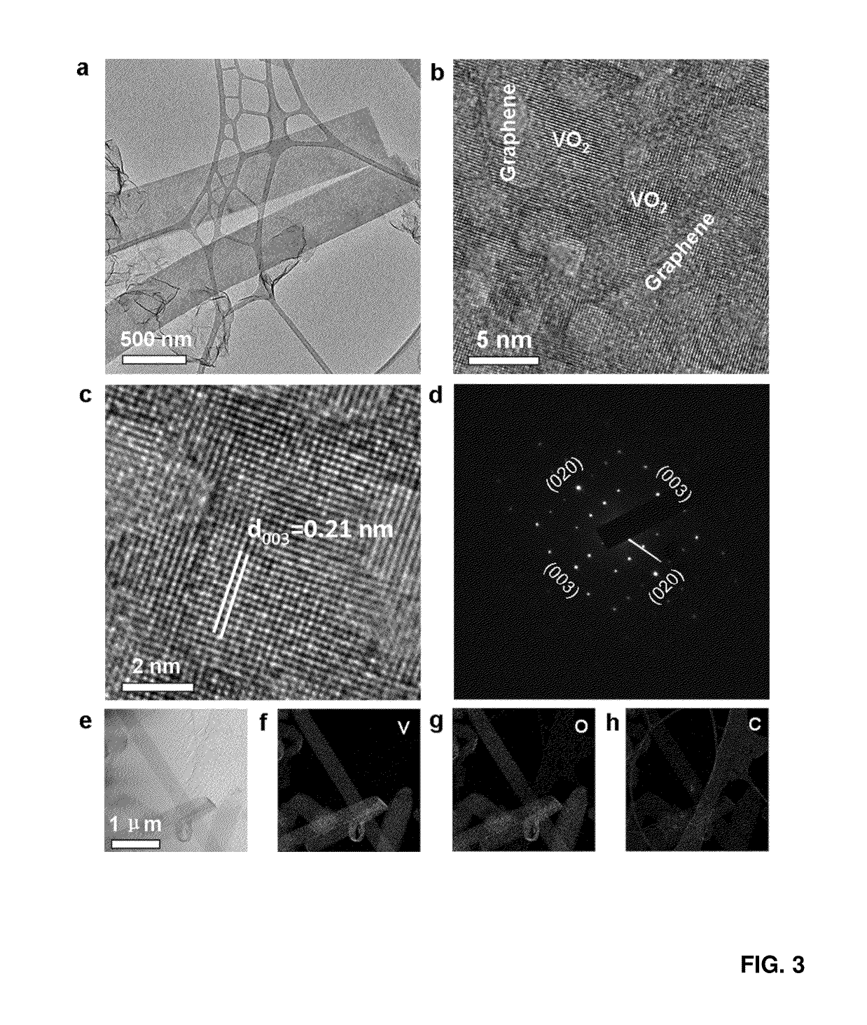

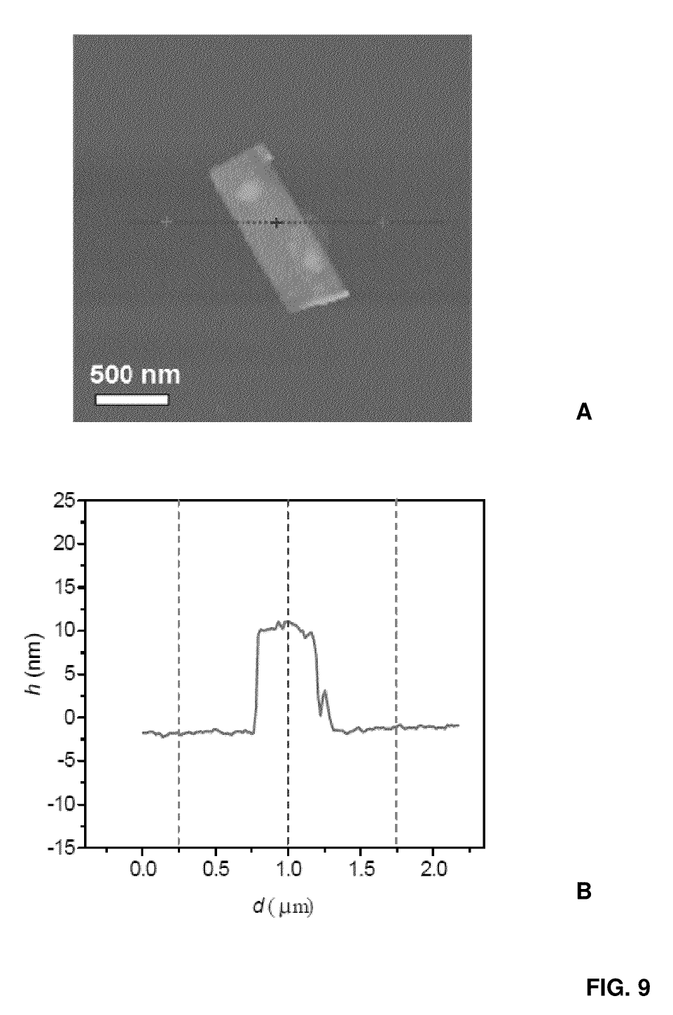

First, the as-prepared VO₂-graphene architectures constructed by numerous ribbons with three-dimensional interpenetrating networks was observed via field emission scanning electron microscopy (FE-SEM) and transmission electron microscopy (TEM) (FIGS. 2B and 3A). The lateral sizes of these building block ribbons are typically in the ranges of 200-600 nm in width and several tens of micrometers in length (FIGS. 2B and 3A). Cross-sectional atomic force microscopy (AFM) images and thickness analyses (FIG. 9) further reveal the same morphology as the observations from SEM and TEM, with a uniform thickness of ˜10 nm. Further inspection using high resolution TEM (HRTEM) (and more specifically from the corresponding selected-area electron diffraction pattern (SAED)) allowed the determination that these ribbons are single crystalline, because of well-defined crystalline lattices (FIGS. 3B-3D).

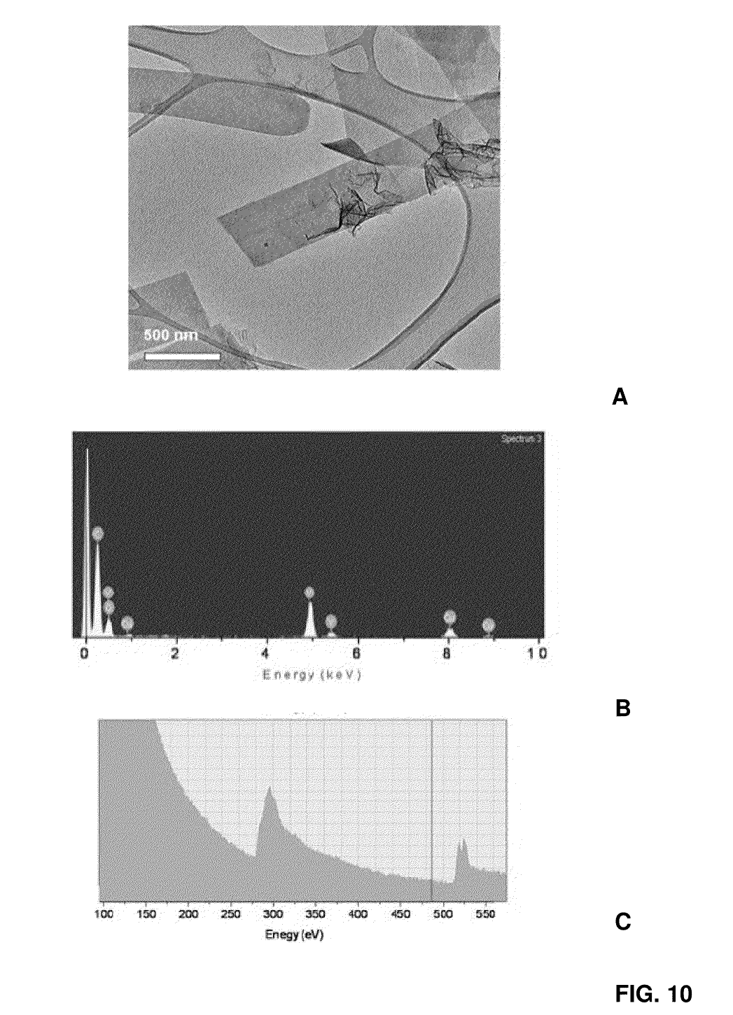

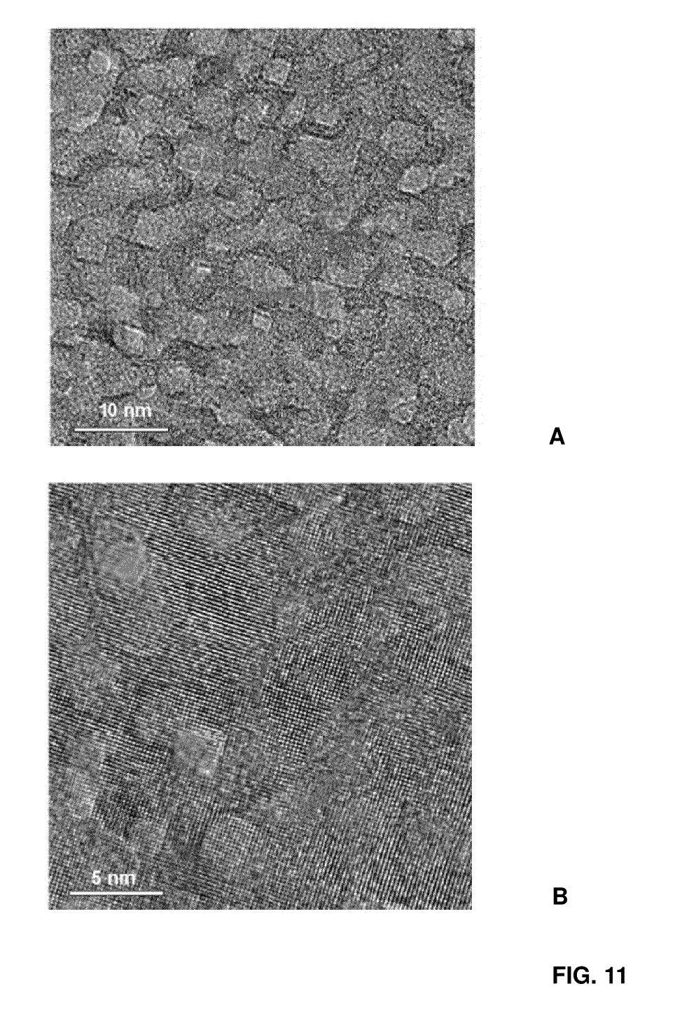

A typical HRTEM image (FIG. 3C) discloses the lattice fringes with a spacing of 0.21 nm, in good agreement with the spacing of the (003) planes of VO₂ (B) (which is described as bilayers formed from edge-sharing VO₆ octahedral). In addition, the nanosheets are tightly covered by graphene layers as confirmed by energy-dispersive X-ray (EDX) and electron Energy-Loss Spectroscopy (EELS) (FIG. 10). Furthermore, the graphene layers decorating the VO₂ ribbons are not continuous (FIGS. 3B and 11), which should result from the strains that were generated during the crystallization process of VO₂ ribbons since some parts of GO have been initially fixed onto the immature ribbons (FIG. 7). Such features can be favorable for the good compatibility with organic electrolyte and easy access for lithium ions, as well as facilitate the fast electron transfer, as applied for lithium storage.

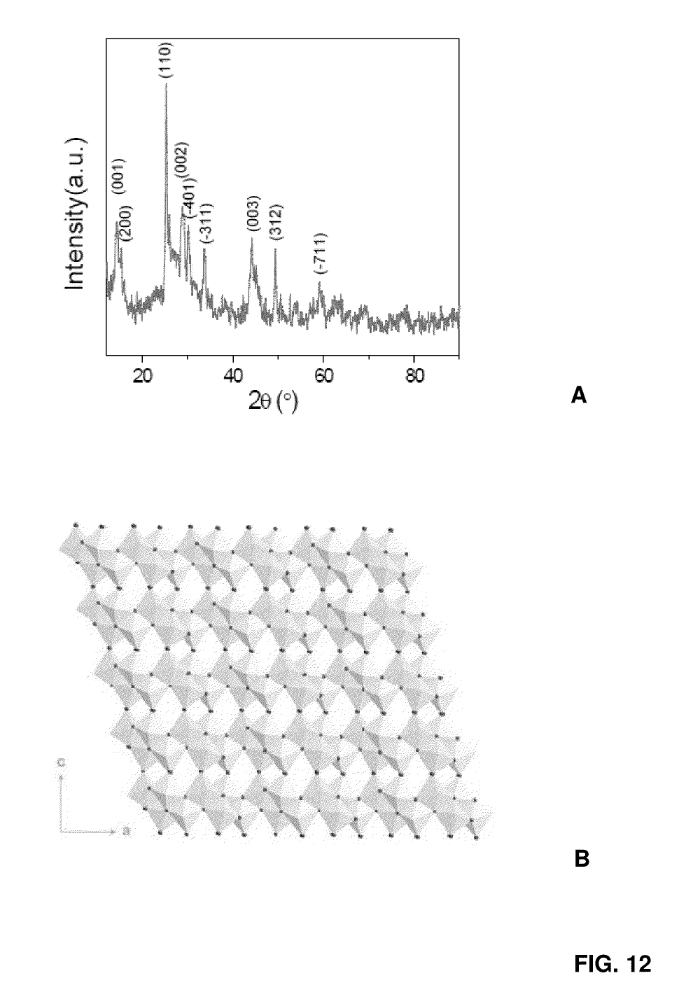

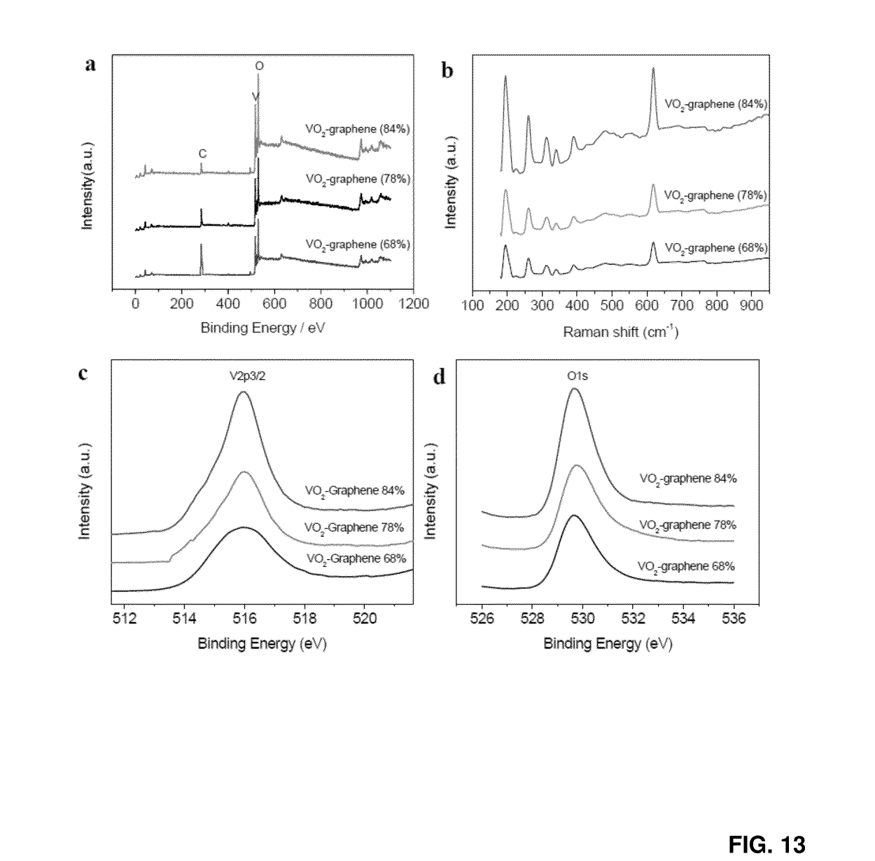

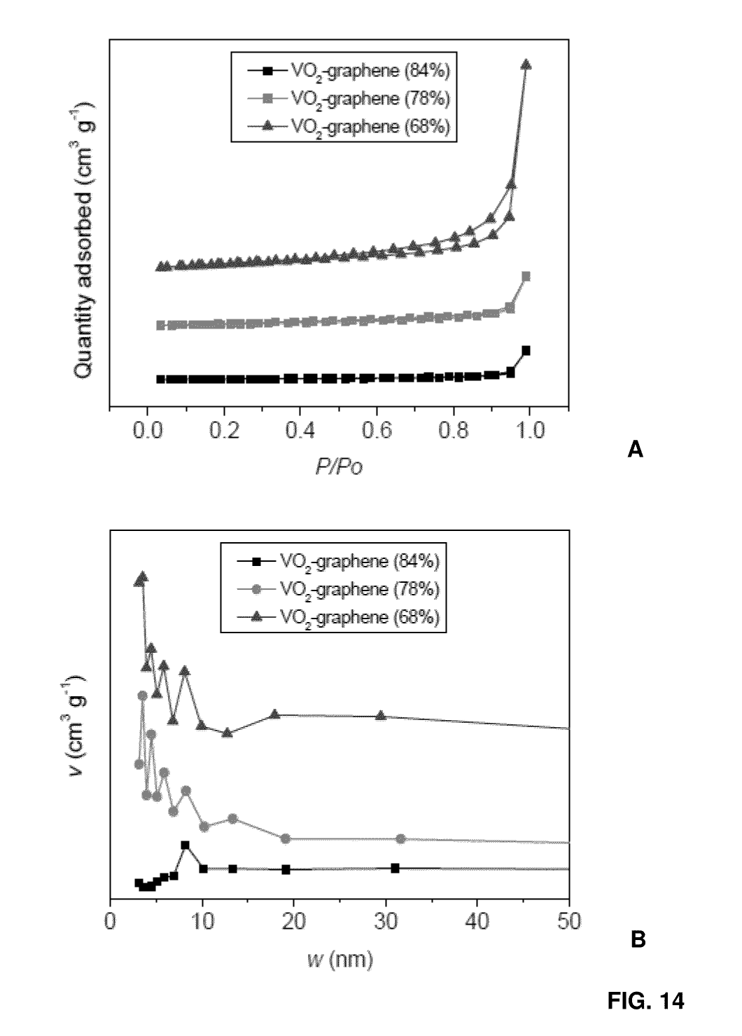

The structure of the ribbons is further analyzed by elemental mapping of vanadium, oxygen and carbon. As presented in FIGS. 3E-H, vanadium, oxygen and carbon atoms are homogeneously distributed in all the ribbons. To gain further insight into the structure of the ribbons, Applicants performed the X-ray diffraction (XRD) patterns, Raman and X-ray photoelectron spectroscopy (XPS) analysis (FIGS. 12-13). The XRD patterns (FIG. 12) are indexed in the space group C2/m with standard lattice constants a=12.03 Å, b=3.693 Å, c=6.42 Å (β=106.6°) for VO₂(B) with a monoclinic structure (JCPDS No. 31-1438). Furthermore, no conventional stacking peak (002) of graphene sheets at 2θ=26.6° is detected, suggesting that the residual graphene sheets may be individual monolayers that are homogeneously dispersed in the resulting three-dimensional architectures. The XPS analysis (FIGS. 13A, C and D) further reveal that the atomic ratio between V and O is close to 1:2, well consistent with those from EDX and EELS. The porous nature of VO₂-graphene architectures is further demonstrated by the nitrogen physisorption measurements. Their adsorption-desorption isotherms exhibit a typical II hysteresis loop at a relative pressure between 0.6 and 0.9 (FIG. 14), characteristic of pores with different pore sizes. Barrett-Joyner-Halenda (BJH) calculations disclose that the pore size distribution is in the range of 3-20 nm, except for the open macropores estimated from the SEM images. The adsorption data indicate specific surface areas of 405, 156 and 66 m² g⁻¹ for the VO₂-graphene architectures with the VO₂ contents of 68.3%, 78.1% and 84.3%, respectively.

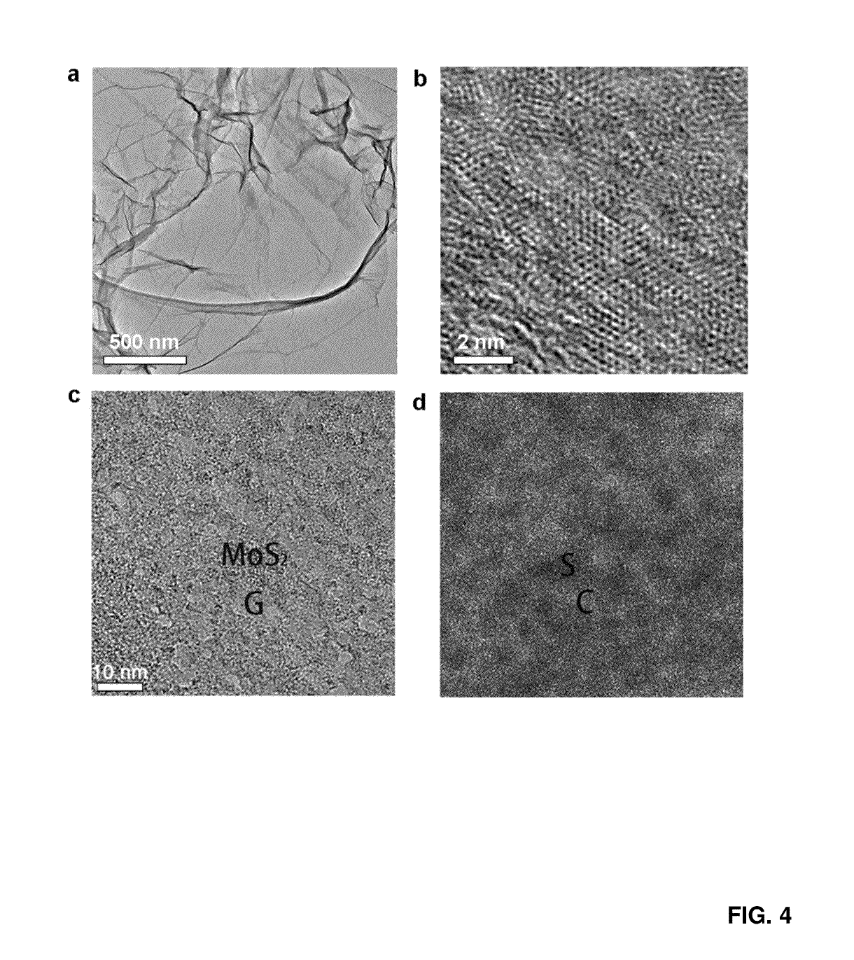

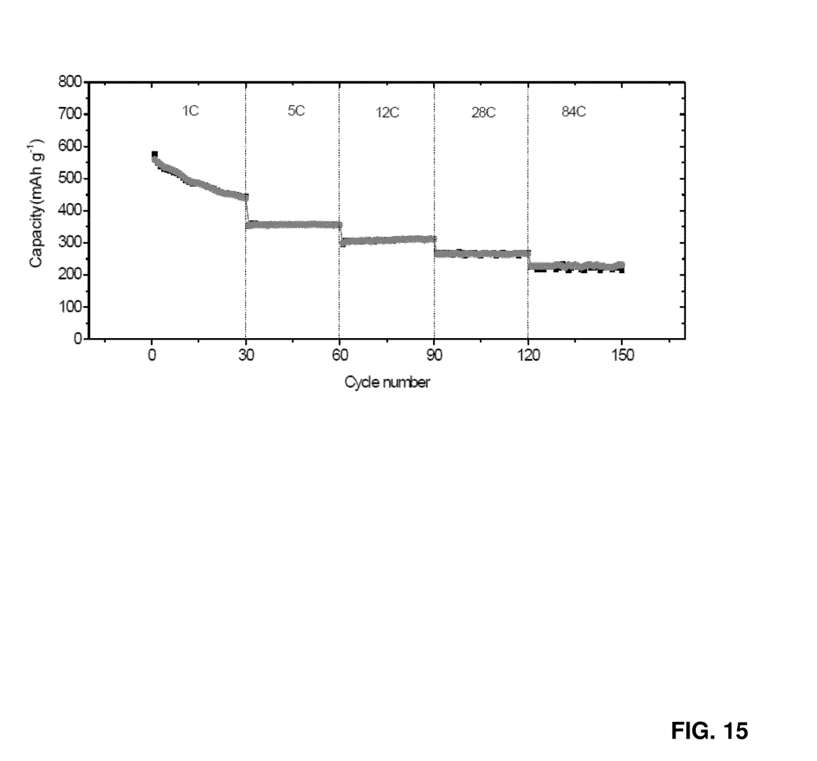

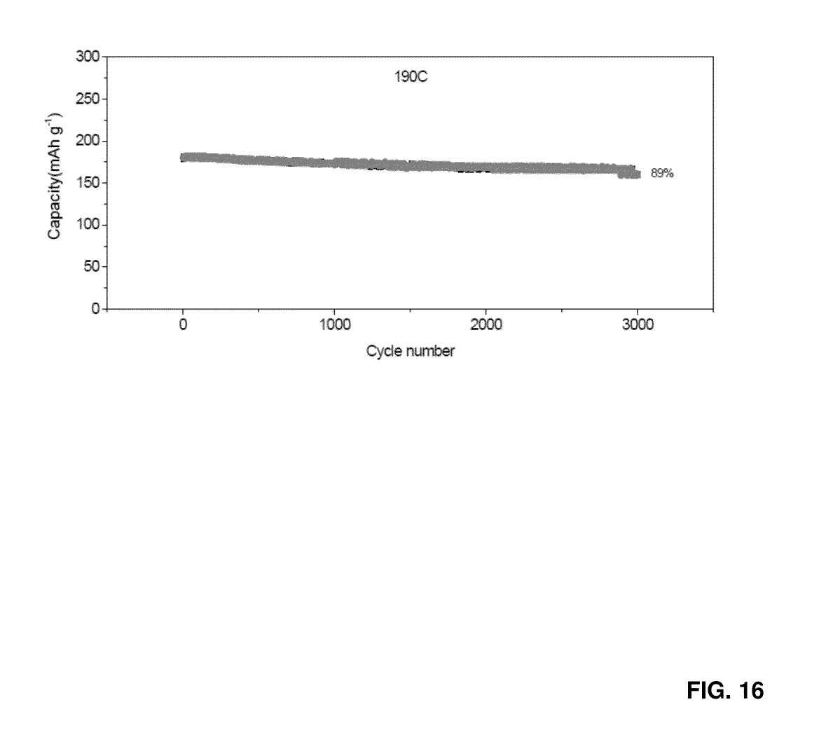

In contrast, the resulting MoS₂-graphene architectures were constructed by numerous thin and continuous nanosheets (FIG. 4). As demonstrated by AFM analysis (FIG. 15), the thickness of the MoS₂-graphene hybrid walls is ˜2 nm, much thinner than that of VO₂-graphene nanoribbons (˜10 nm). In addition, the typical HRTEM image (FIG. 4B) reveals the hexagonal crystalline lattice of MoS₂ on the surface of graphene sheets. Coupled with their elemental mapping analysis, the homogeneous distribution of MoS₂ on graphene is clearly observed as shown in FIG. 4D, where green and blue colors stand for sulfur and carbon, respectively. The composition of MoS₂-graphene architectures is further confirmed by XPS analysis (FIG. 16). An atomic ratio between Mo and S is about ½ for all the MoS₂-graphene samples with different MoS₂ contents, well consistent to that of bulk MoS₂ (FIG. 16).

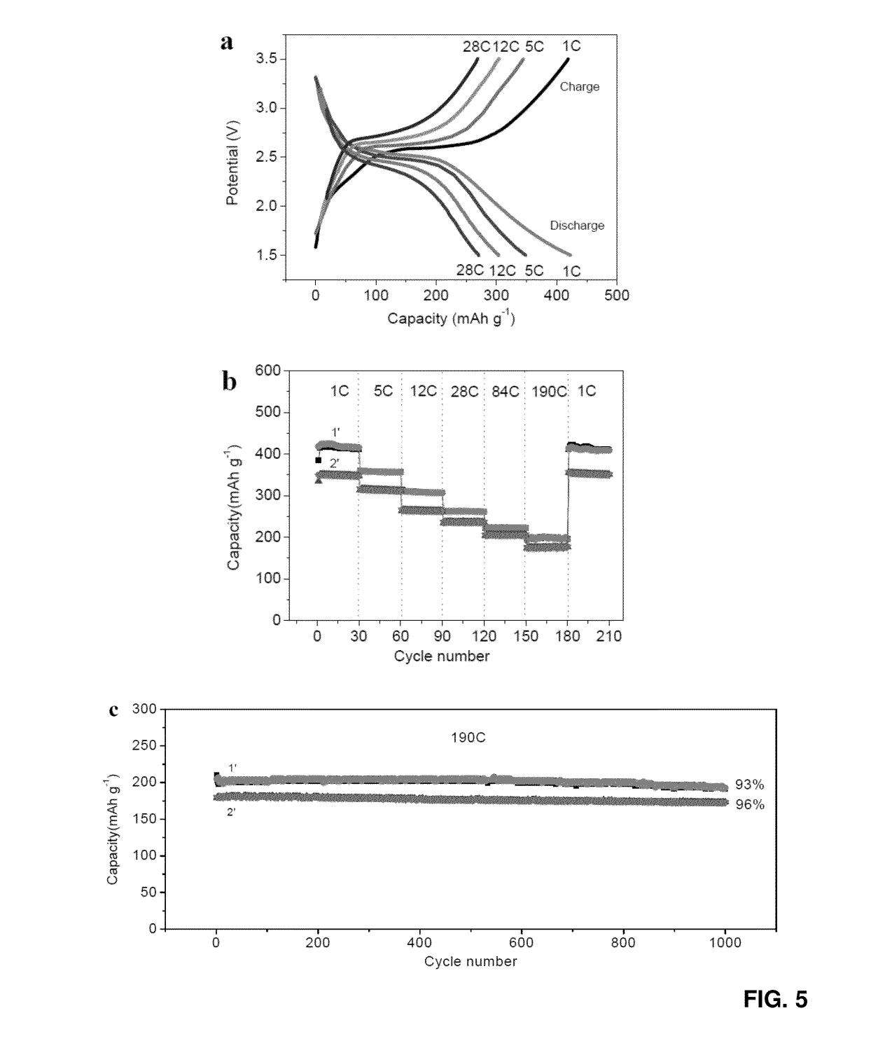

The electrochemical performances of three-dimensional VO₂-graphene and MoS₂-graphene architectures were systematically evaluated as cathode and anode materials, respectively, by galvanostatic discharge (lithium insertion)-charge (lithium extraction) measurements at various rates (nC), where nC corresponds to the full lithium extraction from electrodes in 1/n h. In the case of VO₂-graphene architectures for lithium storage, a very high reversible capacity of 415 mAh g⁻¹ with stable cycle performance is achieved at 1C (FIG. 5), much higher than the commercially available cathode (LiCoO2, ˜140 mAh g⁻¹). This is in stark contrast to those reported for VO₂(B) nanomaterials, which show continuous and progressive capacity decay along with cycling processes.

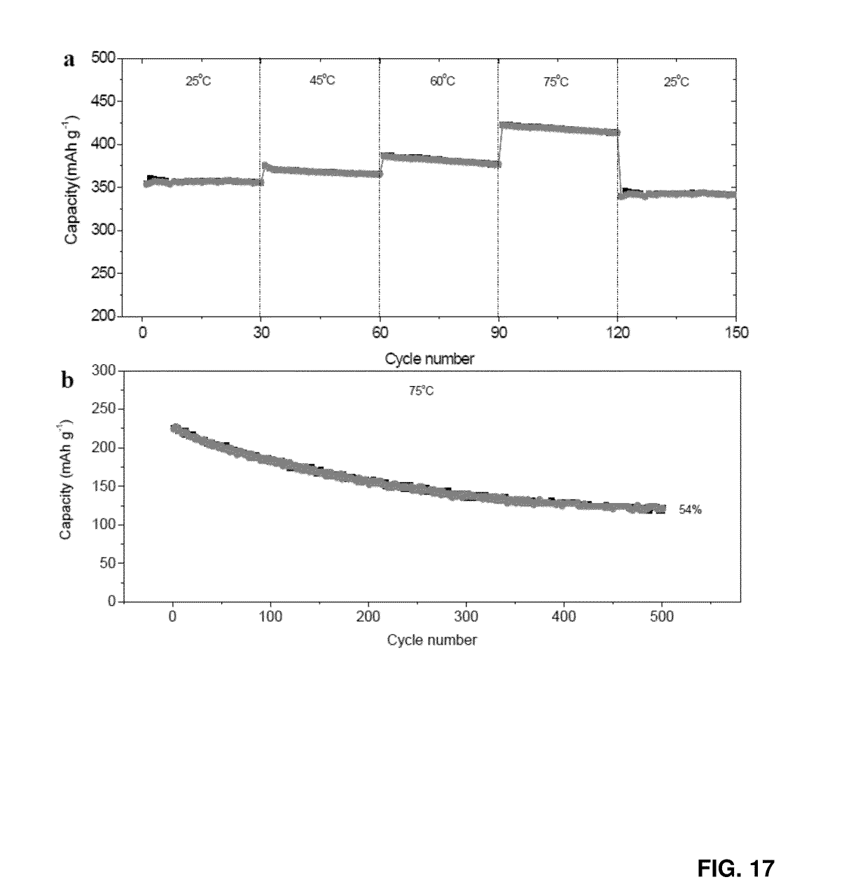

Moreover, the initial reversible capacity is tunable by adjusting the content of VO₂ ribbons in the three-dimensional architectures (FIGS. 5A and 17). The typical discharge-charge profiles (FIG. 5A) further exhibit the classic potential plateaus of VO₂ (B) at ˜2.5 and 2.6 V, corresponding to the formation of LiₓNO₂. Although the electrode potentials are lower than those of commercial cathode LiCoO₂, this has been long considered as an advantage for high-power lithium ion batteries since rapid discharge-charge rates commonly cause the high polarization of electrodes, which would result in the oxidation and decomposition of electrolyte coupled with safety problem of batteries.

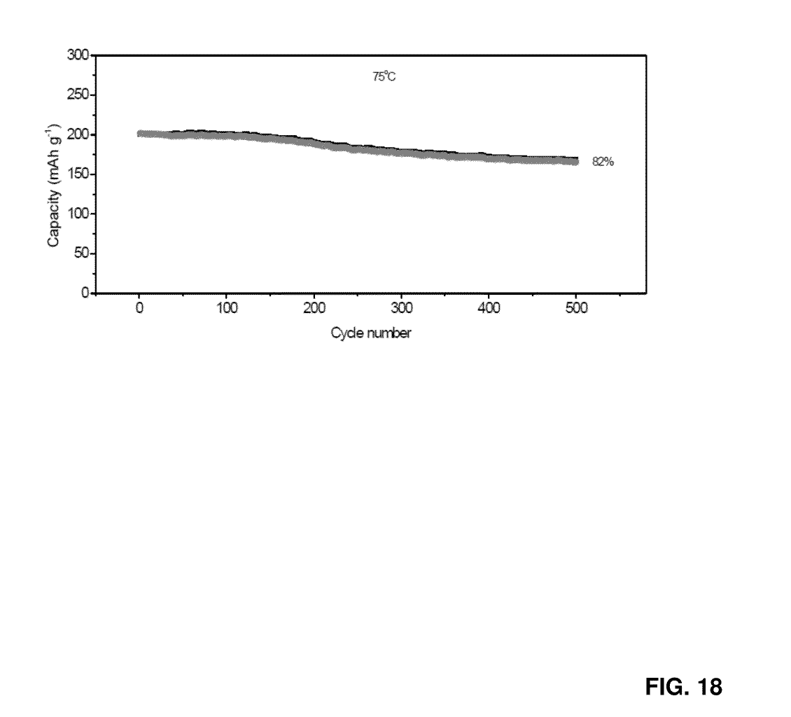

More remarkably, the VO₂-graphene architectures exhibit ultrafast charging and discharging capability (FIGS. 5B and 17-18). For example, at the extremely high rates of 84 C and 190 C (corresponding to 43 and 19 seconds total discharge or charge), the reversible capacities are still as high as 222 and 204 mAh g⁻¹ (FIG. 5B), respectively, for VO₂-graphene architecture with the VO₂ content of 78%. These high discharge-charge rates are two orders of magnitude larger than those currently used in lithium ion batteries. Moreover, even after 1000 cycles at the ultrahigh rate of 190C, both discharge and charge capacities are stabilized at about 190 mAh g⁻¹, delivering over 90% capacity retention (FIGS. 5C and 18). To the best of Applicants' knowledge, such optimal high-rate performance is better than all the cathode materials reported for lithium ion batteries.

In order to understand why VO₂-graphene architectures exhibit such optimal rate performance, the solid-state diffusion time of lithium over VO₂ ribbons was estimated according to the formula of t=L²/D. A very short lithium diffusion time of less than 0.01 s is obtained on the basis of the average thickness of VO₂ ribbons (˜10 nm) and the lithium diffusion coefficient in VO₂ ribbons (10⁻⁹-10⁻¹⁰ cm² s⁻¹). Clearly, a limiting factor for discharging and charging in three-dimensional architectures is the transfer of lithium ions and electrons to the surface of ribbons rather than the conventional solid-state diffusion, which is similar to supercapacitors. In addition to the favorable diffusion kinetics in VO₂-graphene architectures, the unique edge sharing structure of VO₂(B) can also be resistant to the lattice distortions and efficiently preserve the structural stability of VO₂(B) during the long discharge-charge processes. Hence, the ultrafast, supercapacitor-like charge and discharge rates with long cycle life are achieved for Applicants' VO₂-graphene architectures. Furthermore, at the ultrahigh rate of 190 C, the high specific powers are 110 and 96 kW kg⁻¹ for Applicants' VO₂-graphene architecture with VO₂ contents of 78% and 68%, respectively. Assuming that the cathode takes up about 40% of the weight of a complete cell, these values are still 40 times higher than those of the current lithium ion batteries (˜1 kW kg⁻¹).

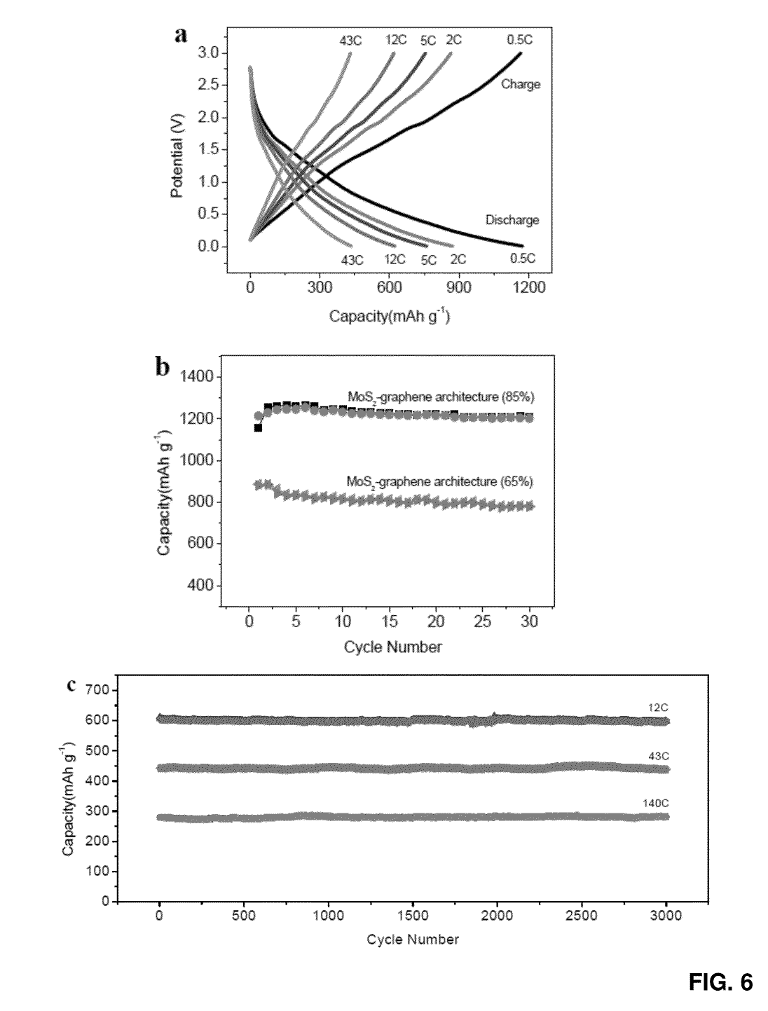

The MoS₂-graphene architectures further demonstrate that Applicants' strategy is still effective to develop optimal anode materials for lithium storage owing to their favorable kinetics for both lithium and electron diffusions. As shown in FIGS. 6A-B, a very high reversible capacity of 1200 mAh g⁻¹ is achieved at 0.5C (600 mA g⁻¹) for the MoS₂-graphene architecture with the MoS₂ content of 85%. Moreover, with significantly increasing the charge-discharge rate to 140 C (corresponding full charge or discharge time is 26 seconds), the high reversible capacity of 270 mAh g⁻¹ is still retained (FIG. 6C). Most importantly, this architecture exhibits ultra-stable cycle performance at various charge-discharge rates. No other capacity decay is observed even after 3000 cycles at all the selected rates of 12 C, 43 C and 140 C (FIG. 6C). This is significantly different from those reported for MoS₂ based materials.

### Example 1.1

### Synthesis of Graphene-Containing Architecture

Graphene oxide (GO) nanosheets were synthesized from natural graphite flakes by a modified Hummers method, the details of which were described elsewhere (Sci Rep. 2, 427 (2012). Three-dimensional VO₂-graphene and MoS₂-graphene architectures were synthesized by a simultaneously hydrothermal synthesis and assembly procedure. In a typical procedure, 10 mL of GO (2 mg mL⁻¹) aqueous dispersions were mixed with different amounts of commercially available V₂O₅ powder or (NH₄)₂MoS₄ with NH₂NH₂ by sonication for 10 min. Next, the resulting mixtures were sealed in Teflon-lined autoclaves and hydrothermally treated at 180° C. for various hours (1.5-24 h). The samples were obtained at 12 h. Finally, the as-prepared samples were freeze- or critical point-dried to preserve the three-dimensional architectures formed during synthesis process.

### Example 1.2

### Characterization Methods

The morphology and microstructure of the samples were systematically investigated by FE-SEM (JEOL 6500), TEM (JEOL 2010), HRTEM (Field Emission JEOL 2100), AFM (Digital Instrument Nanoscope IIIA), XPS (PHI Quantera x-ray photoelectron spectrometer) and XRD (Rigaku D/Max Ultima II Powder X-ray diffractometer) measurements. Nitrogen sorption isotherms and BET surface area were measured at 77 K with a Quantachrome Autosorb-3B analyzer (USA). Electrochemical experiments were carried out in 2032 coin-type cells. The as-prepared VO₂-graphene and MoS₂-graphene monoliths or architectures were directly fabricated as binder/additive-free working electrodes by cutting them into small thin round slices with a thickness of ˜1 mm and processing into these slices into thinner electrodes upon pressing. Pure lithium foil (Aldrich) was used as the counter electrode. The electrolyte consisted of a solution of 1M LiPF₆ in ethylene carbonate (EC)/dimethyl carbonate (DMC)/diethyl carbonate (DEC) (1:1:1 by volume) obtained from MTI Corporation. The cells were assembled in an argon-filled glove box with the concentrations of moisture and oxygen below 0.1 ppm. The electrochemical performance of VO₂-graphene and MoS₂-graphene architectures were tested at various current rates in the voltage range of 1.5-3.5, 0.0-3.0 V, respectively.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of making a three-dimensional graphene composition, said method comprising:
associating a graphene oxide with a metal source to form a mixture; and
reducing the mixture,
wherein the method results in formation of the three-dimensional graphene composition, and wherein the three-dimensional graphene composition comprises:
a reduced metal derived from the metal source; and
a graphene derived from the graphene oxide, wherein the graphene is associated with the reduced metal.

2. The method of claim 1, wherein the associating step and the reducing step occur simultaneously.

3. The method of claim 1, wherein the associating step occurs by a method selected from the group consisting of mixing, sonication, dispersion, heating, hydrothermal treatment, and combinations thereof.

4. The method of claim 1, wherein the associating step comprises sonication.

5. The method of claim 1, wherein the associating step comprises hydrothermal treatment.

6. The method of claim 1, wherein the reducing step comprises heating the mixture.

7. The method of claim 1, wherein the reducing step comprises exposure of the mixture to a reducing agent.

8. The method of claim 7, wherein the reducing agent is selected from the group consisting of hydrazine, sodium borohydride, diamine, and combinations thereof.

9. The method of claim 1, wherein the reducing step results in the reduction of the metal source to the reduced metal.

10. The method of claim 1, wherein the metal source is selected from the group consisting of metals, metal oxides, metal sulfides, transition metals, transition metal oxides, transition metal sulfides, salts thereof, and combinations thereof.

11. The method of claim 1, wherein the metal source is (NH₄)₂MoS₄, and wherein the reduced metal is MoS₂.

12. The method of claim 1, wherein the metal source is FeCl₃.6H₂0, and wherein the reduced metal is FeO.

13. The method of claim 1, wherein the metal source is V₂O₅, and wherein the reduced metal is VO₂.

14. The method of claim 1, wherein the reducing step results in the reduction of the graphene oxide to the graphene.

15. The method of claim 1, wherein the graphene is derived by unzipping of the graphene oxide.

16. The method of claim 1, wherein the graphene is selected from the group consisting of graphene nanoribbons, graphene nanosheets, single-crystalline graphene, graphene monolayers, graphene multilayers, and combinations thereof.

17. The method of claim 1, wherein the graphene forms a continuous network of interconnected monolayers in the three-dimensional graphene composition.

18. The method of claim 1, wherein the graphene forms discontinuous monolayers in the three-dimensional graphene composition.

19. The method of claim 1, wherein the reduced metal forms a crystalline lattice on the graphene.

20. The method of claim 1, wherein the reduced metal forms a uniform layer on the graphene.

21. The method of claim 1, wherein the formed three-dimensional graphene composition is utilized as an electrode material in an energy storage device.

22. A three-dimensional graphene composition comprising:
a graphene; and
a metal associated with the graphene, wherein the three-dimensional graphene composition comprises a three-dimensional architecture.

23. The three-dimensional graphene composition of claim 22, wherein the metal is selected from the group consisting of metals, metal oxides, metal sulfides, transition metals, transition metal oxides, transition metal sulfides, and combinations thereof.

24. The three-dimensional graphene composition of claim 22, wherein the metal is MoS₂.

25. The three-dimensional graphene composition of claim 22, wherein the metal is FeO.

26. The three-dimensional graphene composition of claim 22, wherein the metal is VO₂.

27. The three-dimensional graphene composition of claim 22, wherein the graphene is selected from the group consisting of graphene nanoribbons, graphene nanosheets, single-crystalline graphene, graphene monolayers, graphene multilayers, and combinations thereof.

28. The three-dimensional graphene composition of claim 22, wherein the graphene comprises graphene nanosheets.

29. The three-dimensional graphene composition of claim 22, wherein the graphene comprises graphene nanoribbons.

30. The three-dimensional graphene composition of claim 22, wherein the metal is MoS₂, and wherein the graphene comprises graphene nanosheets.

31. The three-dimensional graphene composition of claim 22, wherein the metal is VO₂, and wherein the graphene comprises graphene nanoribbons.

32. The three-dimensional graphene composition of claim 22, wherein the graphene comprises single-crystalline graphene.

33. The three-dimensional graphene composition of claim 22, wherein the graphene comprises monolayers.

34. The three-dimensional graphene composition of claim 22, wherein the graphene forms a continuous network of interconnected monolayers.

35. The three-dimensional graphene composition of claim 22, wherein the graphene forms a discontinuous monolayer.

36. The three-dimensional graphene composition of claim 22, wherein the metal forms a crystalline lattice on the graphene.

37. The three-dimensional graphene composition of claim 22, wherein the metal forms a uniform layer on the graphene.

38. The three-dimensional graphene composition of claim 22, wherein the metal constitutes from about 60% to about 85% by weight of the three-dimensional graphene composition.

39. The three-dimensional graphene composition of claim 22, wherein the three-dimensional graphene composition has a porous structure with a plurality of pores.

40. The three-dimensional graphene composition of claim 39, wherein the plurality of pores comprise diameters that range from about 3 nm to about 30 nm.

41. The three-dimensional graphene composition of claim 22, wherein the three-dimensional graphene composition has a surface area of about 250 m²/g.

42. The three-dimensional graphene composition of claim 22, wherein the three-dimensional graphene composition is utilized as an electrode material in an energy storage device.
